(19) United States
(12) Patent Application Publication
(10) Pub. No.: US 2013/0088825 A1
(43) Pub. Date: Apr. 11, 2013

(54) NOTEBOOK PC HAVING THREE LAYERS

(71) Applicants: FUMITAKE MIZOGUCHI, KANAGAWA-KEN (JP); RYOTA NOHARA, KANAGAWA-KEN (JP); TETSUYA OHTANI, KANAGAWA-KEN (JP); RYO OTSUKA, KANAGAWA-KEN (JP)

(72) Inventors: FUMITAKE MIZOGUCHI, KANAGAWA-KEN (JP); RYOTA NOHARA, KANAGAWA-KEN (JP); TETSUYA OHTANI, KANAGAWA-KEN (JP); RYO OTSUKA, KANAGAWA-KEN (JP)

(73) Assignee: LENOVO (SINGAPORE) PTE. LTD.

(21) Appl. No.: 13/271,119

(22) Filed: Oct. 11, 2011

(51) Int. Cl. G06F 1/16

(52) U.S. Cl. 361/679.08; 361/679.21; 361/679.27

(57) ABSTRACT

A computer system and a detachable input unit is provided for a user to input data. A computer system may comprise a base, a linking member, and a display housing. The linking member may be pivotally connected to the base. The display housing may be pivotally attached to the linking member. The input unit may be removably attached to the linking member.

### BACKGROUND OF THE INVENTION

The present invention relates generally to computer systems and, more specifically, to apparatus related to tablet computers with detachable keyboards.

In recent years, portable computers have evolved from transportable suitcase style computers, to laptops or notebooks, and then to slate PCs (also referred to as “tablets” or “pure tablets”). Tablet computers have many advantages not found in standard desktop or notebook computers. Chief among these advantages is usually the ability to interface with the tablet computer by writing on or tapping a touch screen display using a stylus or other implement. Input to the computer may thus be entered in a manner similar to writing on paper rather than using a keyboard.

The pure tablet computer provides great efficiency in note-taking environments or in a highly mobile environment where it is difficult to set up or use a keyboard and mouse to input data into the computer. Unfortunately, this advantage is also a great disadvantage because, many users may still find that there is a great need and efficiency in using a keyboard for data entry. Even for existing convertible tablets which have keyboards, users may find they are thick and heavy. In addition, the hinge for the keyboard in existing convertible tablets is not firm, but wobbly.

Therefore, it can be seen that there is a need for a light weight tablet with a detachable keyboard for easy data input.

### SUMMARY

In one aspect, a computer system comprises a base, a linking member pivotally connected to the base; a display housing pivotally attached to the linking member; and an input unit removably attached to the linking member.

In another aspect, an electronic computing device comprises a lower housing; an upper housing pivotally connected to the lower housing, wherein the upper housing is rotatable over substantially 360° with respect to the lower housing; and an input device removably sandwiched between the upper housing and the lower housing.

In a further aspect, a mobile computing device comprises a lower housing; an upper housing pivotally coupled to the lower housing for movement between a tablet configuration and a clam shell configuration, wherein, in the tablet configuration, the lower housing is substantially parallel and adjacent to the upper housing; and a linking member pivotally attached to the upper housing and the lower housing, wherein the linking member has a slot adapted to receive a removable input device.

These and other features, aspects and advantages of the present invention will become better understood with reference to the following drawings, description and claims.

### BRIEF DESCRIPTION OF THE DRAWINGS

FIG. 1A is a perspective view of an exemplary embodiment in a laptop mode;

FIG. 1B is a perspective view of an exemplary embodiment in a semi-desktop mode;

FIG. 1C is a perspective view of the exemplary embodiment in a tablet configuration; and

FIG. 2 is a perspective view of an exemplary embodiment of an input unit with a tablet computer as shown in FIG. 1C.

### DETAILED DESCRIPTION OF EMBODIMENTS

The following detailed description is of the best currently contemplated modes of carrying out exemplary embodiments. The description is not to be taken in a limiting sense, but is made merely for the purpose of illustrating the general principles, since the scope of the embodiments is best defined by the appended claims.

Various inventive features are described below that can each be used independently of one another or in combination with other features.

Broadly, exemplary embodiments comprise a notebook PC with a detachable keyboard. More specifically, exemplary embodiments of a notebook PC may have three layers which may comprise a base, such as a system unit; an input unit, such as a keyboard; and a display unit, such as a liquid crystal display (LCD) unit. According to exemplary embodiments, a linking member, such as two parallel hinges, may interconnect the LCD unit with the system unit. The notebook PC 10 may be configured in either a clam shell configuration or a tablet configuration. In a clam shell configuration, the computing system may be used in a regular laptop mode, or a semi-desktop mode. In a tablet configuration, a keyboard may be removed from the computer system. The LCD unit may be rotatable through an angle of up to substantially 360° relative to the base. In a laptop mode, the keyboard may be substantially parallel to and adjacent to the base of the computing system. In the tablet configuration, the display unit may be substantially parallel to and adjacent to the base of the computing system.

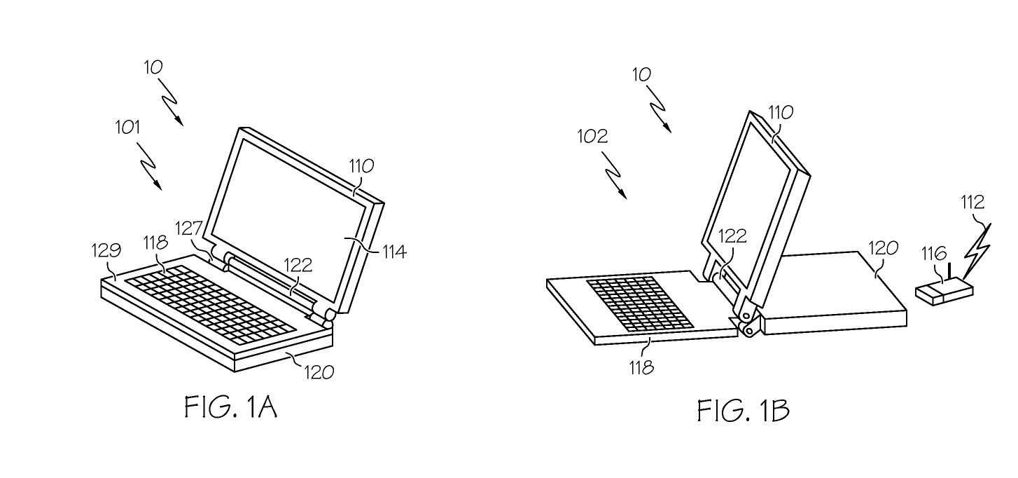

Referring to FIG. 1A, a notebook PC 10 may comprise an upper housing 110, such as a display unit, and a lower housing 120, such as a system unit, for example, wherein the upper housing 110 and the lower housing 120 may be connected via a linking member 122, such as a hinge member.

The notebook PC 10 may include a processor (not shown) within the lower housing 120. A liquid crystal display (LCD) 114, which may be a touch sensitive screen, for example, may be disposed on the upper housing 110. The touch sensitive screen 114 may be coupled to be operable by the processor to display data to a user of the notebook PC 10.

An input device, such as a keyboard 118 may include a hinged end 127 and an opposite disposed end 129. The upper housing 110 and the lower housing 120 may move pivotally around the linking member 122. The upper housing 110 may be rotatable through an angle of up to substantially 360° relative to the lower housing 120.

In operation of an exemplary embodiment, FIGS. 1A-1C show a diagram of the modes of operation for converting a notebook PC 10 from a clamshell configuration, including a laptop mode (FIG. 1A) and a semi-desktop mode (FIG. 1B) to a tablet configuration (FIG. 1C). The notebook PC 10 may change configurations in ways other than those shown in FIGS. 1A-1C, such as from a tablet configuration to a semi desktop mode, from a semi desktop mode to a laptop mode, from a tablet configuration to a laptop mode, for example. Herein, the laptop mode and the semi desktop mode may be together referred to as a clam shell configuration.

When the notebook PC 10 is in the laptop configuration, as shown in mode of operation 101 of FIG. 1A, the upper housing 110 and a linking member 122 may form certain angles with the lower housing 120. The keyboard 118 may be removably sandwiched between the upper housing 110 and the lower housing 120.

Users may use the notebook PC 10 in the laptop mode of operation 101 while sitting in a car, a train, a subway, or an air plane, for example. In the laptop mode, the keyboard 118 may be substantially parallel and adjacent to the lower housing 120.

In the semi desktop mode of operation 102, the lower housing 120 may be rotated around the linking member 122 in such a way that the keyboard 118 may form a 180° angle relative to the lower housing. An input or output connector 116 may be used to connect the cable 112 and the lower housing 120. In a desktop mode of operation 104, users may sit in front of a desk with the slate PC 10 on the desk, for example.

In addition, the keyboard 118 may be removed from the linking member 122. The upper housing 110 may be folded onto the upper housing 120 in such a way that the upper housing 110 may be substantially parallel and adjacent to the lower housing 120 in the tablet configuration 103, as shown in FIG. 1C. In the tablet configuration 103, users may use an object, such as a stylus or a finger to input data.

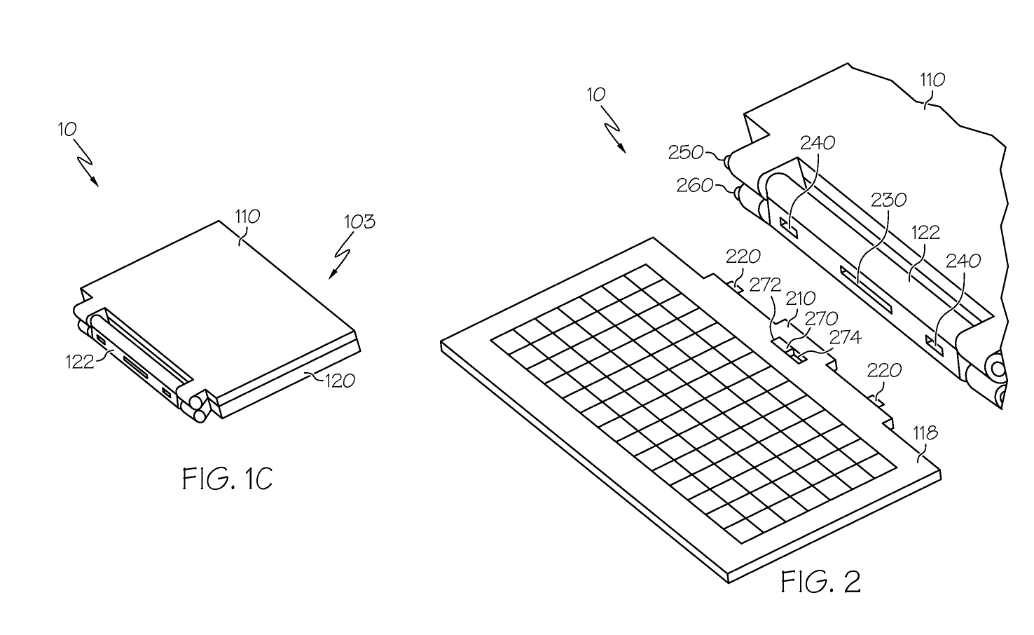

Referring to FIG. 2, the linking member 122 may have two parallel hinges 250 and 260. The first hinge 250 may be connected to the upper housing 110. The second hinge 260 may be connected to the lower housing 120. The linking member 122 may further include a plurality of slots 230 and 240. These slots may be adapted to receive the keyboard 118.

The keyboard 118 may have two hooks 220 and a connector with a guide 210. In addition, the keyboard 118 may include a release knob 270. The two hooks 220 may be adapted to be inserted in the slots 240. The connector with a guide 210 may be adapted to connect to the slot 230.

To connect the keyboard 118 to the linking member 122, users may insert the hooks 220 and the connector with a guide 210 into the slots 240 and 230, respectively. When users want to remove the keyboard 118 from the notebook PC 10, users may slide the release knob 270 from a first end 272 to a second end 274 and disconnect the keyboard 118 from the notebook PC 10. In addition, a spring (not shown) inside the keyboard 118 may urge the release knob 230 back from the second end 274 to the first end 272. Optionally, an input unit may comprise a battery (not shown) that may be removably attached to the linking member 122.

It should be understood, of course, that the foregoing relate to exemplary embodiments of the invention and that modifications may be made without departing from the spirit and scope of the invention as set forth in the following claims.

We claim:

1. A computer system comprising:
a base;
a linking member pivotally connected to the base;
a display housing pivotally attached to the linking member; and
an input unit removably attached to the linking member.

2. The computer system of claim 1, wherein the display housing is rotatable through an angle of up to substantially 360° relative to the base.

3. The computer system of claim 1, wherein the input unit is a keyboard.

4. The computer system of claim 1, wherein the linking member has a plurality of slots.

5. The computer system of claim 4, wherein the input unit has a plurality of protrusions which are adapted to be inserted into the plurality of slots of the linking member.

6. The computer system of claim 1, wherein the input unit has a slide knob whereby moving the slide knob permits the input unit to be detached from the linking member.

7. The computer system of claim 5, wherein the protrusions are hooks.

8. The computer system of claim 5, wherein one of the protrusions is a connector with a guide.

9. The computer system of claim 7, wherein the connector with a guide is situated between hooks.

10. The computer system of claim 1, wherein the input unit comprises a battery.

11. An electronic computing device comprising:
a lower housing;
an upper housing pivotally connected to the lower housing, wherein the upper housing is rotatable over substantially 360° with respect to the lower housing; and
an input device removably sandwiched between the upper housing and the lower housing.

12. The electronic computing apparatus of claim 11, wherein the input device is a keyboard.

13. The electronic computing apparatus of claim 11, wherein the upper housing comprises a touch sensitive screen.

14. The electronic computing apparatus of claim 11 further comprising a linking member wherein the linking member is adapted to connect to the upper housing, the input device, and the lower housing.

15. The electronic computing apparatus of claim 14, wherein the linking member comprises two parallel hinges with a first hinge connected to the upper housing and a second hinge connected to the lower housing.

16. A mobile computing device, comprising:
a lower housing;
an upper housing pivotally coupled to the lower housing for movement between a tablet configuration and a clam shell configuration, wherein, in the tablet configuration, the lower housing is substantially parallel and adjacent to the upper housing; and
a linking member pivotally attached to the upper housing and the lower housing, wherein the linking member has a slot adapted to receive a removable input device.

17. The mobile computing device of claim 16, wherein the clam shell configuration includes a laptop mode and a semi-desktop mode.

18. The mobile computing device of claim 17, wherein, in the laptop mode, the input device is substantially parallel and adjacent to the lower housing.

19. The mobile computing device of claim 16, wherein the upper housing is rotatable through an angle of up to substantially 360° angle relative to the lower housing.

20. The mobile computing device of claim 17, wherein the slot of the linking member is adapted to receive a battery.
